(19) United States
(12) Patent Application Publication
(10) Pub. No.: US 2026/0129714 A1
(43) Pub. Date: May 7, 2026

(54) BEAM HOPPING FOR SATELLITE BEAMS

(71) Applicant: InterDigital Patent Holdings, Inc., Wilmington, DE (US)

(72) Inventors: Umer Salim, Vallauris (FR); Moon IL Lee, Melville, NY (US); Brian Martin, Farnham (GB); Faris Alfarhan, Montreal (CA); Dylan Watts, Montreal (CA); Keiichi Kubota, Tokyo (JP)

(73) Assignee: InterDigital Patent Holdings, Inc., Wilmington, DE (US)

(21) Appl. No.: 18/936,432

(22) Filed: Nov. 4, 2024

(51) Int. Cl. H04W 76/28; H04W 74/0833

(52) U.S. Cl. CPC H04W 76/28; H04W 74/0833

(57) ABSTRACT

Systems, methods, and instrumentalities are disclosed herein for enabling beam hopping for satellite beams. For example, a wireless transmit/receive unit (WTRU) may receive a synchronization signal block (SSB) using a non-terrestrial network (NTN) beam. The WTRU may receive at least one of a system information block (SIB) or a beam hopping SIB (BH-SIB). The SIB may include information associated with a set of discontinuous transmission (DTx)/discontinuous reception (DRx) configurations. The BH-SIB may indicate the set of DTx/DRx configurations. A DTx/DRx configuration from the set of DTx/DRx configurations may be associated with one or more NTN beams. The WTRU may determine the set of DTx/DRx configurations based on at least one of the SIB or the BH-SIB. The WTRU may determine an active beam DTx/DRx configuration from the set of DTx/DRx configurations. The WTRU may monitor for a downlink signal during an active time associated with the active beam DTx/DRx configuration.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are disclosed herein for beam hopping for satellite beams. For example, a device, such as a wireless transmit/receive unit (WTRU), may include a processor, transceiver, and/or memory. The processor, transceiver, and/or memory may be configured to perform one or more of the following.

The WTRU may receive a synchronization signal block (SSB). For example, the WTRU may receive an SSB using a non-terrestrial network (NTN) beam.

The WTRU may receive at least one of a system information block (SIB) or a beam hopping SIB (BH-SIB). The SIB may be, or may include, information associated with a set of discontinuous transmission (DTx)/discontinuous reception (DRx) configurations. The SIB may be associated with SIB1 and/or SIB19. The BH-SIB may indicate a set of DTx/DRx configurations. A DTx/DRx configuration (e.g., each DTx/DRx configuration) from the set of DTx/DRx configurations may be associated with one or more NTN beams.

The WTRU may determine the set of DTx/DRx configurations based on at least one of the SIB or the BH-SIB. For example, the WTRU may determine a set of DTx/DRx configurations based on at least one of a physical cell identity (PCI), an SSB index, an SIB1, the BH-SIB, a frequency band information, or carrier information.

The WTRU may determine an active beam DTx/DRx configuration from the set of DTx/DRx configurations. For example, the WTRU may determine the active beam DTx/DRx configuration from the set of DTx/DRx configurations based on at least one of the set of DTx/DRx configurations, a PCI, an SSB index, an SIB1, the BH-SIB, tracking area information, radio access network (RAN) notification area information, WTRU location information, a timing indication, or satellite ephemeris information. A (e.g., each) DTx/DRx configuration from the set of DTx/DRx configurations may be associated with (e.g., may be further associated with) at least one of a respective cell identity, a respective beam index, or a respective geographical area information.

The WTRU may monitor for a downlink signal during an active time associated with the active beam DTx/DRx configuration.

The WTRU may determine a validity timer associated with the BH-SIB (e.g., the first BH-SIB). The WTRU may determine that the validity timer has expired. Based on the determination that the validity timer has expired, the WTRU may transmit an uplink (UL) transmission that indicates a request for another BH-SIB (e.g., the second BH-SIB). The UL transmission may be, or may include, a random access channel (RACH) message.

The WTRU may receive an indication to implement a DTx/DRx configuration change. The indication may be received using at least one of a short message, a paging, and/or a paging early indication (PEI). Based on the indication, the WTRU may determine another active beam DTx/DRx configuration (e.g., a second active beam DTx/DRx configuration) from the set of DTx/DRx configurations. The WTRU may monitor for another downlink signal (e.g., a second downlink signal) during another active time (e.g., a second active time) that is associated with the second active beam DTx/DRx configuration.

The WTRU may determine the second active beam DTx/DRx configuration from the set of DTx/DRx configurations based on at least one of the set of DTx/DRx configurations, a PCI, an SSB index, an SIB1, the indication to implement the DTx/DRx configuration change, a second BH-SIB, tracking area information, RAN notification area information, WTRU location information, a timing indication, the first active beam DTx/DRx configuration, or satellite ephemeris information.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example satellite beam deployment.

FIG. 3 illustrates an example flow diagram of a determination of non-terrestrial network (NTN) beam discontinuous transmission (DTx)/discontinuous reception (DRx) configuration.

FIGS. 4A-D illustrate example arrangements for DTx and DRx On/Active duration.

FIGS. 5A-C illustrate different examples of DTx/DRx configurations (e.g., with single and two On durations).

FIGS. 6A-C illustrate example DTx/DRx configurations with different cycle arrangements.

### DETAILED DESCRIPTION

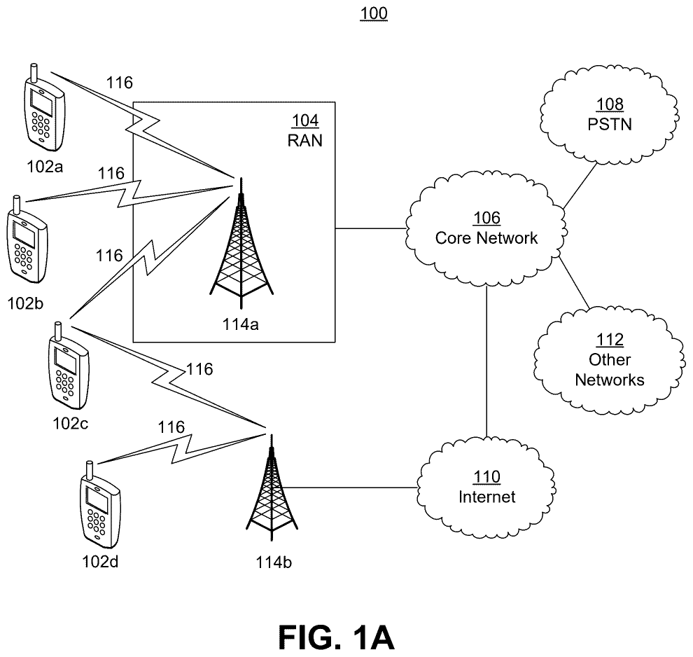

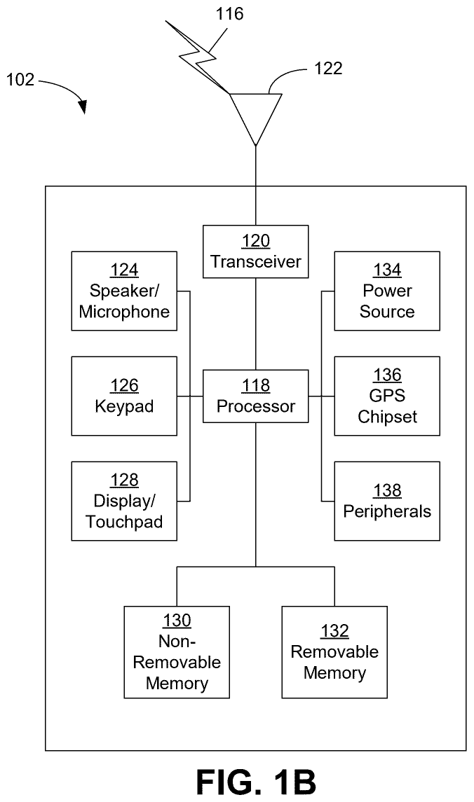

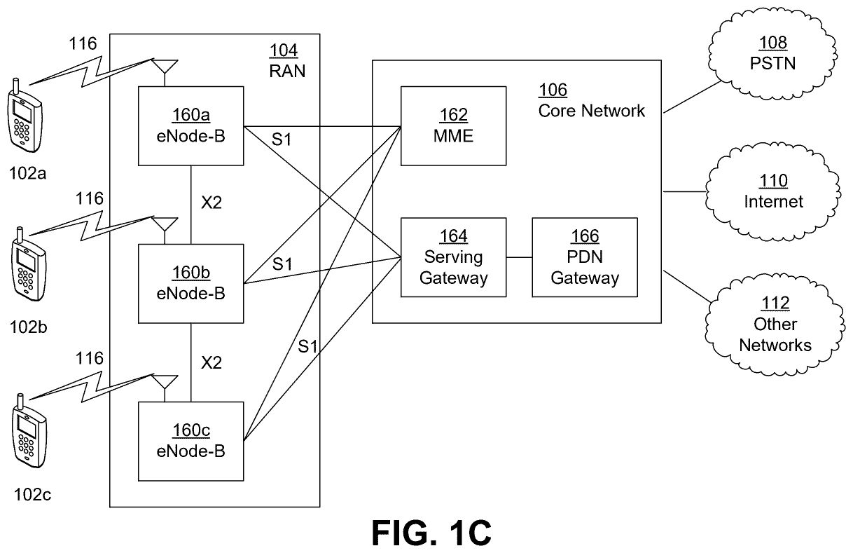

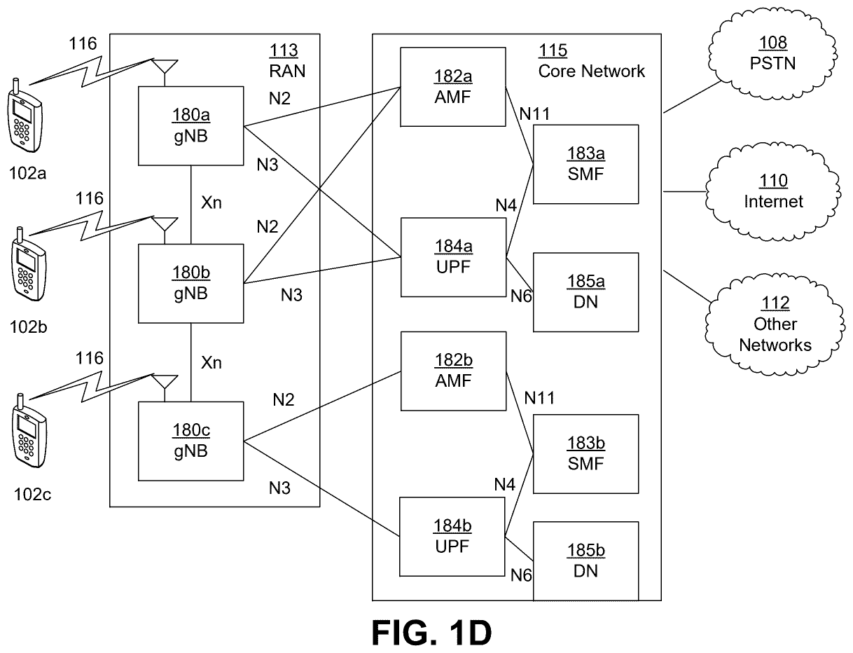

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A non-terrestrial network (NTN) may be configured as described herein. In examples, an NTN (e.g., a basic NTN) may include an aerial or space-borne platform. The NTN may, via a gateway (GW), transport signals from a land-based based network, such as a gNB, to a WTRU (e.g., a user equipment (UE)) and vice versa. One or more aerial and/or space-borne platforms may be classified in terms of orbit, e.g., with non-geosynchronous orbit (NGSO) satellites, including low-earth orbit (LEO) with an altitude range of 300-1500 km and medium-earth orbit (MEO) satellites with an altitude range 7000-25000 km. NGSO satellites may move continuously overhead relative to earth. Geosynchronous orbit (GSO) satellites may remain fixed overhead, e.g., by maintaining an altitude at 35-786 km.

Satellite platforms may be classified (e.g., may be further classified) as having a transparent or regenerative payload. Transparent satellite payloads may implement frequency conversion and/or radio frequency (RF) amplification in both uplink and downlink, e.g., with multiple transparent satellites possibly connected to a (e.g., one) land-based gNB. Regenerative satellite payloads may implement either a full gNB or gNB distributed unit (DU) onboard the satellite. Regenerative payloads may perform digital processing on the signal, e.g., including demodulation, decoding, re-encoding, re-modulation, and/or filtering.

An NTN satellite may support multiple cells. For example, a (e.g., each) cell may include one or more satellite beams. Satellite beams may cover a footprint on earth (e.g., like a terrestrial cell) and may range in diameter from 100-1000 km in NGSO deployments and 200-3500 km diameter in GSO deployments. Beam footprints in GSO deployments may remain fixed relative to earth. In NGSO deployments, the area covered by a beam/cell may change over time, e.g., due to satellite movement. The beam movement may be classified as earth moving. For example, the NGSO beam may move continuously across the earth. The beam movement may be classified as earth fixed. For example, the beam may be steered to provide coverage to a geographic area, e.g., covering a fixed location until a cell (e.g., a new cell) overtakes the coverage area in a discrete and coordinated change.

Non-terrestrial networks may consider one or more of the following: 1) continuous movement of NGSO satellites overhead resulting in frequent and continuous cell change; 2) cell sizes up to 3500 km in diameter; and/or 3) round trip times (RTT) several orders of magnitude larger than terrestrial networks (e.g., up to 541.46 ms).

Network energy savings may be configured. For example, network energy savings may be configured to enable a network to minimize its power consumption from transmission and reception. Such minimization may help to reduce operational costs and/or environmental sustainability.

If there is no data, the design for the network energy savings from the perspective of minimizing transmissions from the network may be efficient. For example, always-on cell-specific reference signal (CRS) may not be used, e.g., in a new radio (NR) system. Energy consumption may be reduced.

For example, the network may still consume energy when not transmitting from other activities, such as baseband (e.g., digital) processing for reception or beamforming. Such idle power consumption may not be negligible in dense networks even when no WTRU is served during a given period. If the network could turn off these activities when not transmitting to a WTRU, energy consumption may be reduced.

A system (e.g., unlike an LTE system and an NR system) may not need (e.g., not require) transmission of always-on synch or reference signals and may support adaptable bandwidth and/or MIMO capabilities. Such adaptation of network resources may enable greater efficiency, e.g., in operating newer deployments and later generations.

Cell discontinuous transmission (DTx)/discontinuous reception (DRx) may be configured. To facilitate reducing gNB downlink transmission/uplink reception active time, a WTRU may be configured with a periodic cell DTx/DRx pattern (e.g., active and non-active periods). The pattern configuration for cell DTx/DRx may be common for the WTRUs configured with this feature in the cell. The cell DTx and cell DRx patterns may be configured and activated separately. A maximum of two cell DTx/DRx patterns may be configured per MAC entity for different serving cells. If cell DTx is configured and activated for the concerned cell, the WTRU may not monitor PDCCH in selected cases or may not monitor semi-persistent scheduling (SPS) occasions during cell DTx non-active duration. If cell DRx is configured and activated for the concerned cell, the WTRU may not transmit on configured grant (CG) resources or may not transmit a scheduling request (SR) during cell DRx non-active duration. This feature may be applicable (e.g., may only applicable) to one or more WTRUs in RRC_CONNECTED state and does not impact Random Access procedure, synchronization signal block (SSB) transmission, paging, and/or system information broadcasting. Cell DTx/DRx operation may be supported (e.g., may only be supported) for a transmission and reception point (TRP) scenario, e.g., a single TRP scenario. Cell DTx/DRx may be activated/deactivated by radio resource control (RRC) signaling or layer 1 (L1) group common signaling. Cell DTx/DRx may be characterized by active duration and/or cycle.

For example, active duration may be the duration that the WTRU waits for to receive PDCCHs or SPS occasions and transmit SR or CG. In this duration, the gNB transmission/reception of PDCCH, SPS, SR, CG, periodic and semi-persistent channel state information (CSI) reports may not be impacted for the purpose of network energy savings.

For example, a cycle may specify the periodic repetition of the active-duration followed by a period of non-active duration.

Active duration and cycle parameters may be common between a cell DTx and a cell DRx if both are configured.

DL coverage may be enhancement. For example, link level may be configured for enhancements for frequency range 1 (FR1)-NTN (e.g., for PDCCH, PDSCH, and/or the like) and/or system level enhancements for FR1-NTN and/or FR2-NTN, e.g., allowing dynamic and flexible power sharing between satellite beams or different satellite beam patterns/sizes (e.g., wide or narrow) across the satellite footprint.

SSB channel enhancement other than SSB periodicity extension may not be considered.

DL channels/signals may be configured to identify the scenarios needing improvement. Based on simulation results, system level and/or link level DL enhancements may be configured. For example, the system level enhancement may be achieved through higher periodicity of SSB.

For an NR NTN, support extended periodicity of the half frames with SS/PBCH blocks may be assumed by a WTRU during an initial access.

The maximum of the additional default value (e.g., apart from the existing 20 ms value) may be at least 160 ms.

Whether 320 ms is supported as the maximum of a default value (e.g., an additional default value) instead of and/or in addition to 160 ms may be considered.

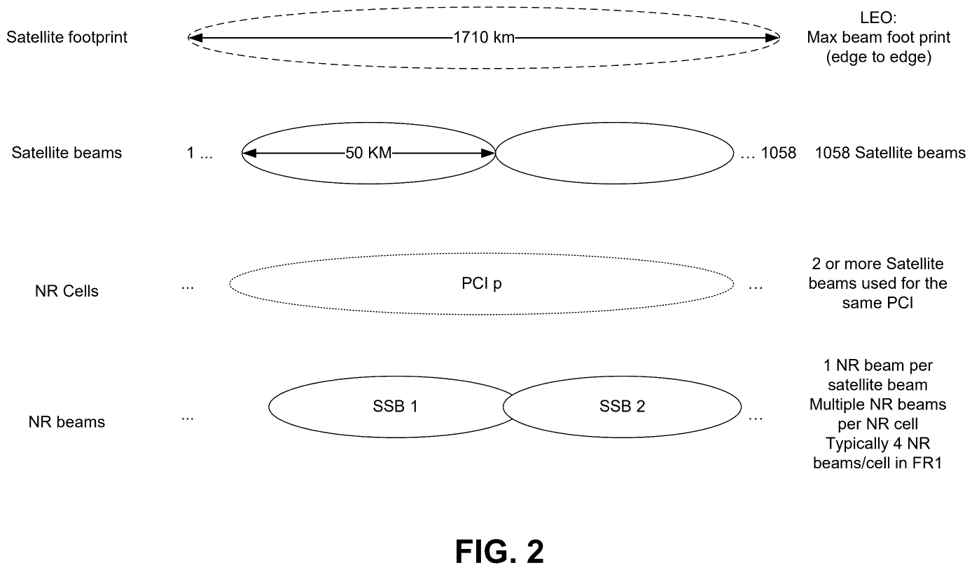

FIG. 2 illustrates an example satellite beam deployment.

A LEO-600 satellite may have a coverage footprint of ˜1.8 million km², equivalent to 1058 satellite beams for a reference beam diameter of 50 km. The payload constraints in terms of (i) available power, (ii) hardware (e.g., RF chains/antenna arrays), and (iii) feeder link capacity, may limit the number of active beams to 10%, 5%, or even ˜2.5%.

An NTN satellite capable of activating 2.5% of ˜1000 beams may illuminate 25 beams simultaneously. A (e.g., one) beam system (e.g., hardware (HW)/radio frequency (RF) chain/antenna array) may need to provide coverage for 1000/25=40 beam footprints through beam hopping. This may result in a (e.g., each) satellite beam footprint illuminated (e.g., downlink (DL)/uplink (UL) transmissions possible) for (e.g., only for) a fraction of time.

With the increased SSB periodicity to 160 ms, the satellite operators may prefer to use different sleep times (e.g., periodicity and active time) for different beams. The WTRUs may be configured when the WTRUs may expect satellite gNB in active transmission/reception.

In examples, satellite operators may use implementation based beam hopping. For example, suitable beams may be activated to fulfill the one or more criteria (e.g., requirements) on sync/SSBs and WTRU traffic and may not allow the hopping to meet the satellite coverage of one or more (e.g., all) beams and manage the WTRU traffic.

NES (Network Energy Savings) associated with the cell DTx/DRx approach may be configured. For example, a network may choose a suitable DTx/DRx pattern for a cell and signal the suitable DTx/DRx pattern to one or more connected Mode WTRUs. Cell DTx/DRx may be limited to WTRU dedicated channels and may not have impact on a common channel (e.g., any common channels).

The NES based Cell DTx/DRx described herein may provide the satellite operators with an example (e.g., one method) to enable beam hopping. Such an example may have one or more scenarios (e.g., limitations): cell level operation for Cell DTx/DRxu Cell DTx/DRx may be applicable (may be applicable only) to RRC_Connected WTRUs; and/or how a network may signal/update DTx/DRx pattern/configuration to one or more Idle mode WTRUs.

In examples, the NES based cell DTx/DRx may configure cell level operation for cell DTx/DRx. For example, the cell DTx/DRx may be a cell level configuration. One or more (e.g., all) the satellite beams under the same cell ID (e.g., physical cell identity (PCI)) may need to follow a DTx/DRx pattern (e.g., a single DTx/DRx pattern) and may need separate transmission (Tx)/reception (Rx) chains to do simultaneous illumination. The satellite operators may not choose different DTx/DRx patterns in different satellite beams under the same PCI, e.g., despite having very different requirements (e.g., due to terrain and user presence, and/or the like) in the satellite beam coverage areas.

In examples, cell DTx/DRx may be applicable (e.g., applicable only) to one or more RRC_Connected WTRUs. As the WTRU dedicated channels (e.g., only the WTRU dedicated channels) may be put to “sleep” or “inactive” mode. With this example (e.g., limitation), one or more (e.g., all) the satellite beams may need to (e.g., may still need to) operate for common channels (e.g., SSBs/SIBs/random access channel (RACH), and/or the like) despite the DTx/DRx active/inactive time. This may be difficult (e.g., impossible) given the capabilities/constraints for satellite systems.

How a network may signal/update DTx/DRx pattern/configuration to one or more Idle mode WTRUs may be considered. The one or more idle mode WTRUs may need to know the DTx/DRx pattern in their relevant coverage area to be able to receive if (e.g., when) beam transmits. Otherwise, there may be increased WTRU power consumption (e.g., transmitting RACH on an occasion where the network (NW) is not receiving) and/or unexpected WTRU behavior (e.g., the WTRU not understanding the absence of SSBs and declaring a link failure).

Based on the example (e.g., scenario) presented and various examples identified herein, how a network may configure and dynamically update satellite beam level DTx/DRx patterns for one or more IDLE and connected mode WTRUs may be configured.

Dynamic SIB based modification to Beam DTx/DRx pattern/configuration may be configured.

A WTRU may receive a set of DTx/DRx configurations. Each DTx/DRx configuration from the set of DTx/DRx configurations may be associated with a respective cell identity, a respective beam index, and/or respective geographical area as part of system information. The WTRU may receive the set of DTx/DRx pattern/configurations through a new beam hopping SIB (BH-SIB). The WTRU may determine the NTN DTx/DRx configuration to apply for reception/transmission based on the received configurations, the WTRU location (e.g., determined based on GNSS), and/or received beam identity (e.g., determined from received SSB). The WTRU may determine a different NTN DTx/DRx configuration to apply based on an indication, e.g., received from the network. The indication may be in the form of a short message, a paging, and/or a paging early indication (PEI).

Dynamic SIB based modification to Beam DTx/DRx pattern/configuration may be configured.

A WTRU may camp on an NTN cell and may detect an SSB with a given cell ID and/or an SSB index.

Based on the SSB, e.g., received through the NTN beam, the WTRU may receive and decode SIB1 and SIB19. Based on the information received through SSB/SIB1/SIB19, the WTRU may determine to receive a BH-SIB. The BH-SIB may provide a set of DTx/DRx configurations and may indicate the signaling that the network may use to select/update a pattern.

The WTRU may determine a set of DTx/DRx configurations associated with NTN beams based on any one or more of the following: PCI/SSB index/SIB1; BH-SIB; and/or frequency band and/or carrier. The NTN beams may be associated with any combination of PCI and SSB index through configuration.

The WTRU may determine a first active beam DTx and a first active beam DRx configuration associated with the NTN beam based on any one or more of the following: the WTRU determined set of DTx/DRx configurations; PCI/SSB index/SIB1; BH-SIB; tracking area information, RAN notification area information, and/or WTRU location information (e.g., area specific DTx/DRx patterns); a timing indication, e.g., service time indication from NTN cell and/or satellite ephemeris information.

The WTRU may detect and/or receive an indication of a change of DTx/DRx configuration from the network. The change indication may be received (e.g., from the network) through any of the (i) short message, (ii) a paging, or (iii) a paging early indication (PEI). The WTRU may determine the signaling procedure (e.g., method) based on the configuration, e.g., as received via/using/through the BH-SIB.

The WTRU may determine to read (e.g., and/or decode) the BH-SIB based on the received notification even if the BH-SIB is valid, e.g., according to the prior received validity timer.

The WTRU may determine a second active beam DTx and a second active beam DRx configuration associated with the NTN beam based on any one or more of the following: the WTRU determined a set of DTx/DRx configurations; PCI/SSB index/SIB1; a notification from the network e.g., a short message, a paging, a PEI, and/or the like; a BH-SIB (e.g., freshly received); tracking area information, RAN notification area information, and/or WTRU location information; a timing indication, e.g., a service time indication from an NTN cell; the WTRU determined first active beam DTx and first active beam DRx pattern/configuration; and/or satellite ephemeris information.

The WTRU may monitor one or more DL signals/channels (e.g., SSBs/SIBs/Paging and/or the like) during (e.g., only during) the active time of the determined second beam DTx pattern/configuration.

The WTRU may transmit RACH requesting to receive the BH-SIB based on a condition, e.g., expiry of validity timer associated with the BH-SIB.

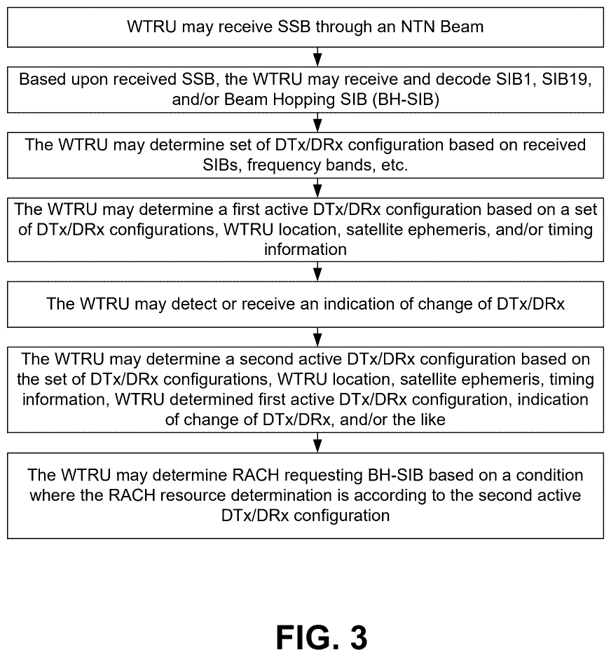

FIG. 3 illustrates an example flow diagram of a determination of NTN beam DTx/DRx configuration.

As described herein and as illustrated in FIG. 3, the WTRU may receive an SSB. For example, the WTRU may receive an SSB using a NTN beam.

The WTRU may receive at least one of a SIB or a BH-SIB. The SIB may be, or may include, information associated with a set of DTx/DRx configurations. The SIB may be and/or may be associated with SIB1 or SIB19. The BH-SIB may be, or may include, a set of DTx/DRx configurations. A DTx/DRx configuration (e.g., each DTx/DRx configuration) from the set of DTx/DRx configurations described herein may be associated with one or more NTN beams.

The WTRU may determine the set of DTx/DRx configurations based on at least one of the SIB or the BH-SIB. For example, the WTRU may determine the set of DTx/DRx configurations based on at least one of a PCI, an SSB index, an SIB1, the BH-SIB, a frequency band information, or carrier information.

The WTRU may determine an active beam DTx/DRx configuration from the set of DTx/DRx configurations. For example, the WTRU may determine the active beam DTx/DRx configuration from the set of DTx/DRx configurations based on at least one of the set of DTx/DRx configurations, a PCI, an SSB index, an SIB1, the BH-SIB, tracking area information, RAN notification area information, WTRU location information, a timing indication, or satellite ephemeris information. A (e.g., each) DTx/DRx configuration from the set of DTx/DRx configurations may be associated with (e.g., may be further associated with) at least one of a respective cell identity, a respective beam index, or a respective geographical area information.

The WTRU may monitor for a downlink signal during an active time associated with the active beam DTx/DRx configuration.

The WTRU may determine a validity timer associated with the BH-SIB (e.g., the first BH-SIB). The WTRU may determine that the validity timer has expired. Based on the determination that the validity timer has expired, the WTRU may transmit an UL transmission that indicates a request for another BH-SIB (e.g., the second BH-SIB). The UL transmission may be, or may include, a RACH message.

The WTRU may receive an indication to implement a DTx/DRx configuration change. The indication may be received using at least one of a short message, a paging, and/or a PEI. Based on the indication, the WTRU may determine another active beam DTx/DRx configuration (e.g., a second active beam DTx/DRx configuration) from the set of DTx/DRx configurations. The WTRU may monitor for another downlink signal (e.g., a second downlink signal) during another active time (e.g., a second active time) that is associated with the second active beam DTx/DRx configuration.

The WTRU may determine the second active beam DTx/DRx configuration from the set of DTx/DRx configurations based on at least one of the set of DTx/DRx configurations, a PCI, an SSB index, an SIB1, the indication to implement the DTx/DRx configuration change, a second BH-SIB, tracking area information, RAN notification area information, WTRU location information, a timing indication, the first active beam DTx/DRx configuration, or satellite ephemeris information.

The examples described herein may provide flexible control for the satellite operator at the beam level granularity to provide satellite coverage despite the severe HW/RF/power limitations.

The examples described herein may provide WTRU power savings as the WTRUs may listen (e.g., may only listen) to SSBs/Paging if (e.g., when) a relevant beam is known to be active and may transmit a RACH (e.g., may transmit a RACH only) on the active RACH occasions (ROs).

Satellite beam hopping for a NTN Network(s) may be configured.

A WTRU may use one or more procedures (e.g., steps) and/or examples described herein. The WTRU may be configured to use the examples and/or procedures (e.g., steps) in any order. One or more of the examples and/or procedures (e.g., steps) may be repeated by the WTRU.

In examples, the WTRU may receive an SSB through an NTN beam. For example, the WTRU may use the SSB reception to perform time and/or frequency synchronization with the cell/beam used to transmit the SSB.

Based on the received SSB, the WTRU may determine to read (e.g., and/or decode) SIB1 through the NTN beam (e.g., the same NTN beam). The WTRU may determine (e.g., further determine) to read other SIBs, e.g., SIB19.

The WTRU may receive SSB and/or the other SIBs through more than one NTN beams, e.g., a first NTN beam and a second NTN beam. Receiving SSB and/or other SIBs through more than one NTN beams described herein may be an example if (e.g., when) the WTRU is in an overlapping area of the NTN beams.

In examples, the WTRU may detect/receive a set of configurations for beam DTx/DRx. For example, the WTRU may detect and/or receive an indication from the network. The WTRU may receive the indication through the NTN beam. The WTRU may detect the SSB and for which a cell is not barred. If the WTRU detects more than one NTN beams (e.g., having different SSB indices or different PCIs), the WTRU may select a suitable NTN beam (e.g., the beam with higher/highest reference signal received power (RSRP), SSB, and/or the like) to receive the indication. In examples, the WTRU may receive the indication through the same NTN beam for which the WTRU reads SIBs (e.g., SIB1, SIB19, and/or the like) to camp on the associated cell.

The indication may include a set of one or more of the following: a set of DTx configurations; a set of DRx configurations; an active DTx configuration if (e.g., when) multiple DTx configurations are indicated; or an active DRx configuration if (e.g., when) multiple DRx configurations are indicated.

The WTRU may consider the set of configurations as candidate configurations. The WTRU may determine an active DTx and/or an active DRx configuration among the set of configurations according to one of the examples described herein.

The indication may provide DTx/DRx configurations associated with any one or more of the following attributes: frequency band, e.g., the frequency band associated with the NTN beam; frequency carrier (e.g., absolute radio frequency channel number (ARFCN)), e.g., the frequency carrier associated with the NTN beam; tracking area information; RAN notification area information; geographic location on earth; satellite location information (e.g., based on ephemeris data as broadcast in SIB19); a cell identity; an SSB index; an SSB periodicity; a non-cell defining SSB (e.g., beam); a wide NTN beam, e.g., if (when) a satellite is using a wide beam to transmit an SSB and (e.g., some) common channels; a narrow NTN beam, e.g., if (e.g., when) a satellite is using a narrow beam to transmit some signals and channels, e.g., WTRU specific signals and channels; and/or time triggers if (e.g., when) certain DTx/DRx configurations may get activated and/or deactivated.

If there are configurations associated with one or more attributes, the indication may provide the configurations and/or the mappings associating the configuration to suitable attributes.

In examples, the signaling may provide a configuration for a beam DTx/DRx. For example, the WTRU may detect and/or receive an NTN DTx/DRx indication from the network. The WTRU may detect and/or receive DTx/DRx configuration based on one or more of the following: frequency band, e.g., the frequency band associated with the NTN beam; frequency carrier (e.g., ARFCN), e.g., the frequency carrier associated with the NTN beam; SSB periodicity, e.g., a first DTx/DRx configuration if SSB periodicity is smaller than a threshold and a second DTx/DRx configuration if SSB periodicity is larger than a threshold, or the WTRU may assume no DTx/DRx if SSB periodicity is smaller than a threshold and a DTx/DRx configuration if SSB periodicity is larger than a threshold; the NTN beam being detected/known to be a wide NTN beam; the NTN beam being detected/known to be a narrow NTN beam; an SSB (e.g., using a physical property of the SSB or through explicit indication from the network); an SIB1; an SIB19; and/or a SIB (e.g., a new SIB) providing the first information for beam DTx/DRx (e.g., a beam hopping SIB, (BH-SIB)).

The SSB described herein may include one or more of the following: a selection of synchronization sequences; a MIB payload; PBCH PHY bits; and/or PBCH DMRS sequence initialization

The SIB1 described herein may include one or more of the examples. In one example, the network may provide an indication as part of the SIB1 based on which the WTRU determines the DTx/DRx configuration. The SIB1 based indication may be combined with one or more other parameters, e.g., frequency carrier, SSB periodicity, and/or the like. In another example, the SIB1 may provide an indication to indicate whether a known/configured DTx/DRx pattern is active or not. The pattern may have been known to the WTRU, e.g., through other means. The WTRU may determine the pattern based on one or more other parameters. In examples, the SIB1 may provide an indication to indicate whether the cell/beam is using DTx/DRx or not. Based on the indication and if the cell/beam is using DTx/DRx, the WTRU may determine the DTx/DRx configuration from other SIBs or having been known based on other parameters, e.g., frequency band, carrier, and/or SSB periodicity (e.g., being known, detected, and/or the like). In examples, the SIB1 may provide an indication, and based on the indication, the WTRU may determine to read additional system information to determine DTx/DRx configuration. For example, the WTRU may determine that the NTN beam is using DTx/DRx pattern based on reading the SIB1. Based on the determination that the NTN beam is using DTx/DRx pattern, the WTRU may determine to read a BH-SIB that provides DTx/DRx configuration (e.g., a set of DTx/DRx configurations) for the NTN beam. In examples, the SIB1 may provide additional information for the BH-SIB, e.g., whether this is broadcast or on-demand and/or additional parameters (e.g., RACH) to acquire the BH-SIB.

In examples, configuration parameters for a beam DTx/DRx may be configured. The WTRU may detect or receive a DTx/DRx configuration. The configuration may provide a set of DTx/DRx configurations where the WTRU may determine a (e.g., one) configuration being active (e.g., based on SSB periodicity, frequency band, frequency carrier, based on an explicit network indication, and/or the like) according to one of the examples described herein. In one example, the configuration may provide a set of DTx/DRx configurations and an active DTx/DRx configuration.

A DTx configuration and/or DRx configuration may include any of the following parameters: an NTN beam identity; a DTx/DRx on duration; a DTx/DRx cycle; a DTx/DRx cycle start offset; a DTx-DRx on duration offset; a DTx/DRx second on duration; a second on duration offset; a DTx/DRx configuration modification mechanism; a DTx/DRx validity period; a complement and/or reset indication; DTx/DRx activation status; a DTx/DRx activation mechanism; DTx/DRx configuration association attributes; and/or DTx/DRx configuration type.

An NTN Beam identity may be, or may include, the NTN beam associated with the configuration. For example, the NTN beam identity may be associated with any one or more of the following: a satellite beam identity; an SSB index, e.g., if (e.g., when) the network intends to provide different DTx/DRx configurations for different SSB beams; a non-cell defining SSB index, e.g., if (e.g., when) the network intends to provide different DTx/DRx configurations for different beams through which non-cell defining SSBs are being transmitted; a CSI-RS identity, e.g., if (e.g., when) the network intends to enable DTx/DRx operation for beams identified by CSI-RS signals; and/or a cell identity (e.g., PCI or global cell identity), e.g., this may be relevant if (e.g., when) the network intends to provide different DTx/DRx configurations for different cell identities.

The network may provide DTx/DRx configuration against a combination of parameters, e.g., Cell ID (e.g., PCI) and/or an SSB. In which case, the network may provide DTx/DRx configurations for a combination of the parameters. For example, the network may provide DTx/DRx configuration for suitable combinations of PCI and SSB indices based on its deployment. Other combinations may be used by the network to associate different DTx/DRx configurations.

DTx/DRx on duration may be associated with on duration or active duration. The WTRU may receive and/or transmit through the associated NTN beam.

For beam DTx, the WTRU may receive downlink transmissions from the associated NTN beam. The DL transmissions may be one or more of SSBs, PDCCHs, SPS PDSCH, and/or the like. For beam DTx, in this duration, the gNB DL transmission of signals/channels (e.g., SSB, PDCCH, SPS, and/or the like) may not be impacted based on the beam DTx configuration. The WTRUs may expect to receive no DL transmission outside of the on or active duration indicated.

For beam DRx, the WTRU may transmit RACH, SR, or CG-PUSCH. In this duration, the gNB reception of RACH, SR, CG, periodic, and/or semi-persistent CSI report may not be impacted based on the beam DRx configuration. The WTRUs may be expected to transmit no UL transmission outside of the indicated on/active duration.

In examples, the inactive duration may be specified, e.g., instead of and/or in addition to the active duration.

A DTx/DRx cycle may specify the periodic repetition of the on or active duration, e.g., followed by a period of off or non-active duration.

A DTx/DRx cycle start offset may provide an indication of an offset with respect to a suitable reference, e.g., frame, half-frame, sub-frame, a set of 10 frames/sub-frames, the frame/half-frame carrying SSBs, and/or the like. The offset may be the time between the reference time and the start of the DTx/DRx cycle or the start of the DTx/DRx on/active duration. The offset may be provided at the granularities of frame, sub-frame, slot, symbol, or in the units of time, e.g., seconds, ms, and/or the like.

A DTx-DRx on duration offset may provide an indication of an offset between the on duration of DTx configuration and DRx configuration if (e.g., when) the configuration is provided for DTx and DRx. If the on durations for DTx and DRx start at the same time instant, the offset may be set to zero (e.g., zero). The DTx-DRx on duration offset may be provided by indicating the offset of the on duration for DRx configuration with reference to the start of the on duration of DTx configuration. The offset may be indicated in an absolute time scale, e.g., ms, or 1/10 ms, or 1/32 ms, and/or the like. In examples, the offset may be indicated in terms of system timing, e.g., frame, half-frame, sub-frame, a set of 10 frames/sub-frames, the frame/half-frame carrying SSBs, and/or the like.

DTx/DRx second on duration may be a second on duration or active duration where the WTRU may receive and/or transmit through the associated NTN beam.

For beam DTx, the WTRU may receive downlink transmissions from the associated NTN beam. The DL transmissions may be one or more of SSBs, PDCCHs, SPS PDSCH, and/or the like. For beam DTx, in this duration, the gNB DL transmission of signals/channels (e.g., SSB, PDCCH, SPS, and/or the like) are not impacted based on the beam DTx configuration. In one example, the second on duration may be (e.g., may only be) configured if the cycle exceeds a threshold value. In another example, the second on duration for DTx may be used for one or more (e.g., all) DL channels/signals. In examples, the WTRUs may be configured to receive a first set of DL signals/channels in the (e.g., first) on duration and a second set of signals/channels in the second on duration of DTx configuration. The first set and/or the second set may include one or more of the following signals/channels: SSB; SIB1; SIB19; BH-SIB; other SIBs; PDCCH common search spaces; PDSCH in an inactive mode; PDCCH WTRU specific search spaces; PDSCH in a connected mode (e.g., SPS-PDSCH); and/or CSI-RS.

For example, the WTRUs may be configured to receive cell specific signals and/or channels in the first on duration and the WTRU specific signals and/or channels in the second on duration. In one example, the WTRUs may be configured to receive one or more (e.g., all) signals/channels in the (e.g., first) on duration while WTRU specific (e.g., only WTRU specific) signals/channels in the second on duration.

For beam DRx, in the second on duration, the gNB reception of RACH, SR, CG, periodic and semi-persistent CSI report, and/or the like may not be impacted based on the beam DRx configuration. In one example, the WTRUs may transmit one or more (e.g., all) UL transmissions in the second on duration. In another example, the WTRUs may be configured to transmit a first set of UL transmissions in the (e.g., first) on duration and a second set of UL transmissions in the second on duration.

In examples, the second on duration may be configured to WTRUs in an RRC state (e.g., any RRC state), such as an RRC idle, inactive, or connected. In examples, the second on duration may be configured to WTRUs (e.g., WTRUs only) for a specific RRC state. In examples, the WTRUs may be configured a second on duration (e.g., based DTx/DRx configuration) during (e.g., only during) an RRC inactive state. In examples, the WTRUs may be configured a second on duration (e.g., based on the DTx/DRx configuration) during (e.g., only during) an RRC connected state. If (e.g., when) the second on duration is configured/activated to be used during (e.g., only during) a specific RRC state, the WTRU may consider the second on duration invalid after exiting the specific RRC state.

In examples, there may be a specific signaling to indicate a second on duration. The signaling to indicate a second on duration may be part of the WTRU RRC state. The second on duration may be configured or intended to be used/activated. In examples, the second on duration may be configured through a dedicated RRC signaling.

In examples, the second on duration may be activated/modified by providing a WTRU specific or group common signaling. This may be an example if (e.g., when) the second on duration is intended to be used for a specific RRC state or for specific signals/channels transmission/reception.

As an example for DTx configuration with (e.g., first) on duration and second on duration, if DTx cycle is 320 ms, a first on duration of 20 ms (e.g., from 0-20 ms) may be configured to allow the WTRUs to receive SSB/SIB1, and/or the like. A second on duration of 20 ms (e.g., from 160-180 ms) may be configured for the WTRUs to be able to receive Msg2/4, e.g., in response to the RACH transmission (e.g., Msg 1/Msg3). Between the on duration (e.g., the first on duration) and the second on duration of DTx configuration, a suitable on duration for DRx may be configured, e.g., an on duration of 20 ms (e.g., from 80-100 ms) to allow the WTRU to transmit a RACH Msg1 and/or Msg 3, and/or the like.

In examples, the second on duration may not be configured.

A second on duration offset may provide an indication of an offset associated with the second on duration. The second on duration offset may be provided with reference to the cycle start, the start of the DTx (e.g., first) on duration, the start of the (e.g., first) DRx on duration, and/or the like.

In examples, second on duration offset may be provided by indicating the offset of the second on duration for DTx/DRx configuration, e.g., in an absolute time scale, e.g., ms, 1/10 ms, 1/32 ms, and/or the like. In examples, the offset may be indicated in terms of system timing, e.g., frame, half-frame, sub-frame, a set of 10 frames/sub-frames, the frame/half-frame carrying SSBs, and/or the like.

DTx/DRx configuration modification mechanism may indicate how the DTx/DRx configuration (e.g., active configuration) may be updated. The DTx/DRx active configuration update may happen without a (e.g., any) network signaling/indication, e.g., DTx/DRx validity timer expiry, configurations associated with location (e.g., WTRU location, reference locations, and/or the like), or configurations associated with satellite location, orbit, and/or the like, and/or based on the WTRU detecting a change in one of the signal transmissions (e.g., SSB periodicity, and/or the like).

The DTx/DRx configuration update may happen through an indication (e.g., an explicit network indication). The network may provide one or more modifications to the DTx/DRx configuration. One or more of the following modification possibilities may be indicated by the network: short message based update; paging or paging early indication based update; system information update indication (e.g., update of value tag associated with SIB1, SIB19, BH-SIB, and/or the like); common signaling based modification; RRC signaling providing updated/modified configuration; PHY layer WTRU dedicated signaling; and/or PHY layer group common DCI based modifications.

DTx/DRx validity period may specify a period of time during which WTRUs may consider the DTx/DRx configuration to stay valid, e.g., in the absence of any explicit modification information received through the network. The validity period may be specified with reference to system timing, e.g., system frame number, and/or the like. In examples, the validity period may be specified by indicating a timer value, and upon the expiry of a timer, the WTRU may consider the DTx/DRx configuration becoming invalid. The WTRU may be configured to decrement the timer, e.g., based on absolute time, system time, system frame number, and/or the like.

Complement and/or reset indication may specify whether the configuration is complementary to any (e.g., all) of the previously received configurations or if the configuration is a reset configuration. In case of complementary configuration, the WTRU may consider the active durations for the received configuration to complement the previous active duration, e.g., the effective active duration for the beam DTx/DRx is the union of the received configuration active duration and previous active duration. In case of reset configuration, any of the previous configurations for the relevant beam DTx/DRx may not be valid anymore, and the currently received configuration (e.g., only the currently received configuration) may be valid.

A DTx/DRx activation status may indicate whether the configuration is active or not, e.g., upon the WTRU reception of the configuration. If (e.g., when) the configuration status is set to not active, the configuration may provide the activation mechanisms.

A DTx/DRx activation mechanism may provide a subsequent signaling, e.g., which may activate the beam DTx/DRx configuration. This may be useful for an example if (e.g., when) the configuration is currently not active. One or more of the following activation mechanisms may be indicated by the network: system information based activation; common signaling based activation; RRC signaling activating the existing configuration; PHY layer WTRU dedicated signaling based activation; and/or PHY layer group common DCI based activation.

DTx/DRx configuration association attributes may provide where the configuration is associated with any one or more of the following: tracking area information; RAN notification area information; geographic location on earth; satellite location information (e.g., based on ephemeris data as broadcast in SIB19); a cell identity; an SSB index; a non-cell defining SSB (e.g., beam); a wide NTN beam, e.g., if (e.g., when) a satellite is using a wide beam to transmit SSB and (e.g., some) common channels; a narrow NTN beam, e.g., if (e.g., when) a satellite is using a narrow beam to transmit some signals and channels, e.g., WTRU specific signals and channels; and/or time triggers (e.g., or service time triggers) if (e.g., when) certain DTx/DRx configurations may get activated and/or deactivated.

In examples, if (e.g., when) the configuration is associated with one or more attributes, the relevant values for the attributes may be provided as part of the configuration.

In examples, if (e.g., when) the configuration is associated with one or more attributes, the WTRU may be configured to assume detecting a change in DTx/DRx configuration if (e.g., when) the WTRU detects a change in the attributes.

In examples, if (e.g., when) the configuration is associated with one or more attributes, the WTRU may be configured to determine a (e.g., a second) DTx/DRx configuration if (e.g., when) the WTRU detects a change in the attributes.

DTx/DRx configuration type may provide whether the configuration type is DTx (e.g., DTx only), DRx (e.g., DRx only), or a joint DTx/DRx configuration.

The WTRU may be configured to assume any of the following for a reception (e.g., for the signal reception) during on or active duration of the DTx configuration: the network may not transmit any signal; the network may transmit an SSB (e.g., only an SSB); the network may transmit SSB and SIB1 (e.g., only SSB and SIB1); the network may transmit SSB, SBI1, and SIB19 (e.g., only SSB, SBI1, and SIB19); and/or the network may transmit SSB (e.g., and/or SIB1 and/or SIB19) with a reduced periodicity (e.g., only SSB (and/or SIB1, and/or SIB19) with a reduced periodicity).

The WTRU may be configured to assume one or more of the following for the on or active duration of the DRx configuration: the WTRU may not be allowed to transmit any signal; the WTRU may not be allowed to transmit any signal except RACH (e.g., RACH for initial access); and/or the WTRU may not be allowed to transmit any signal except if it is configured with a RACH configuration with ROs during the inactive duration of the DRx configuration.

In examples, the beam DTx and beam DTx may have the same cycle/periodicity. In examples, the beam DTx may have a cycle/periodicity, e.g., that is an integer multiple of beam DRx periodicity, or vice versa.

The on duration or active duration may be the same duration or different duration for beam DTx and beam DRx.

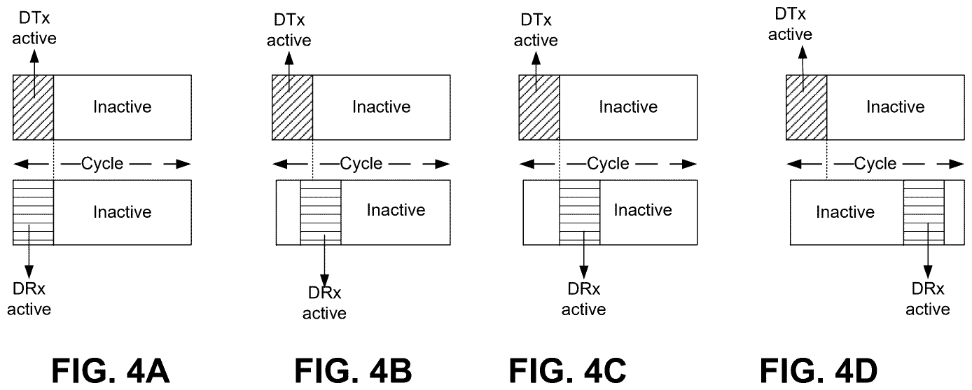

FIGS. 4A-D illustrate example arrangements for DTx and DRx On/Active duration. For example, the active duration for beam DTx and beam DRx may have the following arrangements: fully overlapping active durations (e.g., as illustrated in FIG. 4A); partial overlapping active durations (e.g., as illustrated in FIG. 4B); non-overlapping consecutive durations (e.g., as illustrated in FIG. 4C); and/or non-overlapping non-consecutive durations (e.g., as illustrated in FIG. 4D).

As described herein, FIGS. 4A-D illustrate some arrangements for DTx and DRx on or active durations. The cycle (e.g., periodicity) and active duration for DTx and DRx may be kept the same (as illustrated in FIGS. 4A-D). Those skilled in the art may appreciate that the arrangements may be applicable to the cases if any of the cycle (e.g., periodicity) and active duration for DTx and DRx is different. The arrangements for different start of on/active durations for DTx/DRx configurations may be configured, e.g., using appropriate values for DTx/DRx on duration offset as part of DTx/DRx configuration.

The non-overlapping active durations for DTx and DRx with an offset (e.g., a specific offset) may be useful in examples, e.g., where an UL transmission is expected or triggered after the WTRU receiving a DL transmission. In examples, the WTRU may be configured to receive SSB/SIB1 and/or the like during DTx on/active duration and transmit RACH in the UL within the same DTx/DRx cycle. In examples, PRACH transmission in the UL may be triggered by a DL transmission (e.g., a PDCCH order, a paging reception, a PEI reception, a short message reception, a system information change indication reception, and/or the like). In examples, the WTRU may be transmitting an SR in the UL direction after receiving the SSB/SIB1, and/or the like in the DL direction within the same DTx/DRx cycle. To realize such cases of an (e.g., one) UL and a (e.g., one) DL in the same DTx/DRx cycle, a suitable value of DTx/DRx on duration offset may be configured incorporating one or more of the following: DL propagation delay for DL channels; delay for the WTRU to receive and decode the DL data signals/channels; the WTRU preparation time for UL transmission; UL propagation delay; and/or timing advance.

In examples of DTx/DRx configurations, the cycle may start with an on duration for DL, and the on duration for UL may start, e.g., after a configured offset value.

In examples, the cycle may start with an on duration for the UL, and the on duration for the DL may start, e.g., after a configured offset value. This may be an example case if (e.g., when) the WTRU is expected to receive a response in the DL for its UL transmission made within the same DTx/DRx cycle. This may be an example if (e.g., when) the WTRU transmits RACH preamble (Msg-1 or Msg-A) in the UL direction and may be expected to receive the response to its UL transmission (e.g., Msg-2 or Msg-B) in the same cycle. In another example may be if (e.g., when) the WTRU transmits Msg-3 of RACH procedure in the UL and may be expected to receive the response Msg-4 in the DL on/active duration within the same cycle.

In examples, the offset arrangements for on duration for DTx configuration and the on duration for DRx configuration may be configured (e.g., configured only) if (e.g., when) the DTx cycle exceeds a threshold, the DRx cycle exceeds a threshold, and/or DTx/DRx cycles exceed a threshold.

In examples, a configuration (e.g., a single configuration) may be configured for both beam DTx and beam DRx.

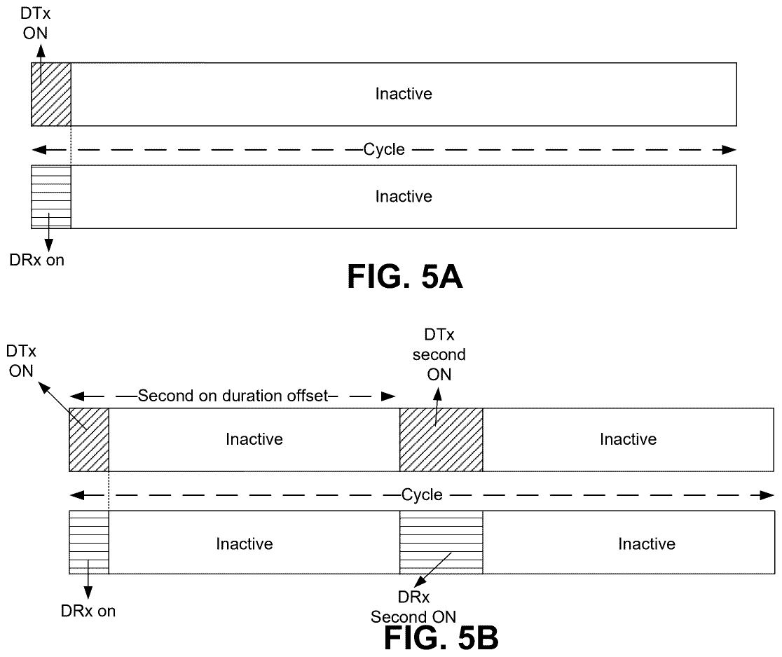

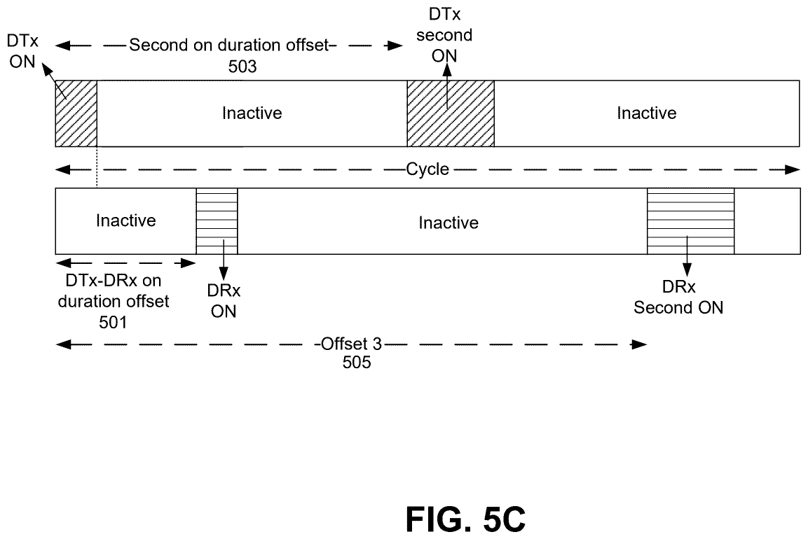

FIGS. 5A-C illustrate examples of DTx/DRx configurations with single and two On durations. For example, FIGS. 5A-C illustrate three different examples of DTx/DRx configurations. FIG. 5A illustrates an example DTx/DRx configuration where a single (e.g., first) on duration is configured, and the on duration for DTx/DRx configuration may be aligned. FIG. 5B illustrates an example DTx/DRx configuration where both DTx and DRx have two on durations. For example, the first on duration and second on duration may have different durations (e.g., as illustrated in FIG. 5B). The second on duration offset may provide the offset of the second on duration in the arrangement. FIG. 5C illustrates example DTx/DRx configurations having second on duration enabled. The (e.g., first) DRx on duration offset with respect to the cycle start (e.g., DTx on duration) may be indicated through a DTx-DRx on duration offset (e.g., 501). The offset of the second DTx on duration may be indicated through a second on duration offset (e.g., 503). The offset of the second DRx on duration may be denoted as offset 3 (e.g., 505). The offset 3 (e.g., 505) may be based on one or more of the second on duration offset (e.g., 503) and/or the DTx-DRx on duration offset (e.g., 501). In examples, an additional parameter may be provided to indicate offset 3 (e.g., explicitly) as part of DTx/DRx configuration.

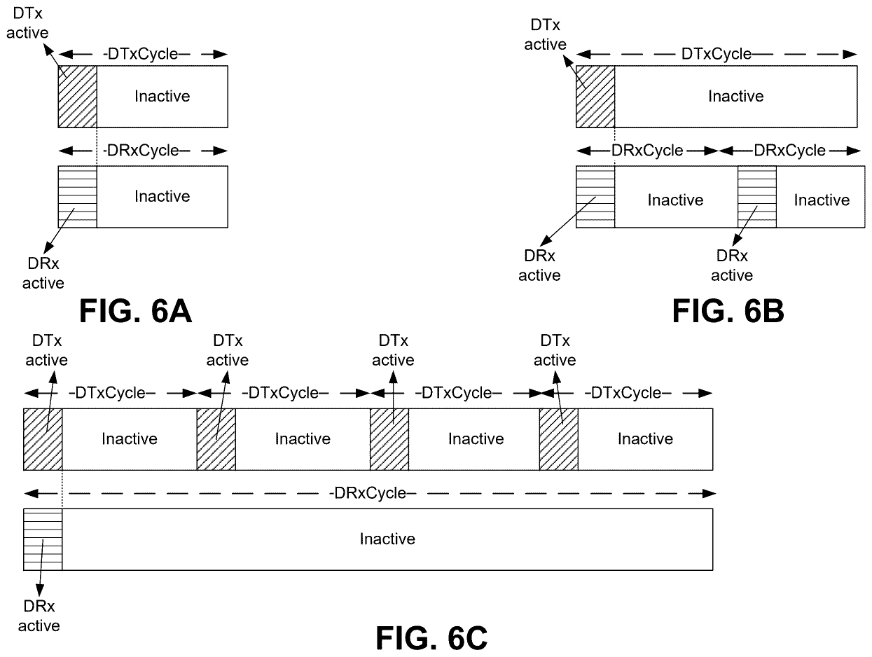

FIGS. 6A-C illustrate example DTx/DRx configurations with different cycle arrangements. For example, FIGS. 6A-C illustrate DTx/DRx configurations with different cycle arrangements associated with DTx and DRx configurations. FIG. 6A illustrates an example arrangement where DTx and DRx configurations have the same cycle. FIG. 6B illustrates an example arrangement where DTx cycle is twice as long as DRx cycle. FIG. 6C illustrates an example arrangement where the DRx cycle is 4 times as long as the cycle duration of DTx or there are 4 cycles of the DTx in the cycle duration of one DRx cycle.

In examples, the WTRU may determine active DTx/DRx configuration. For example, the WTRU may determine a beam DTx/DRx configuration, e.g., an active DTx/DRx configuration, to apply for its reception/transmission. The WTRU may determine a beam DTx/DRx configuration if (e.g., when) the WTRU may have received or determined a set of DTx/DRx configurations according to one or more of examples, described herein.

In examples, the WTRU may determine an active DTx/DRx configuration based on the WTRU receiving an indication from the network that the network is deploying DTx/DRx. For example, the indication received from the network may be associated with the received system information through SSB, SIB1, SIB19 or BH-SIB.

In examples, the WTRU may determine an active DTx/DRx configuration based on the WTRU detecting or receiving an indication associated with a change of DTx/DRx configuration (e.g., an indication to implement a DTx/DRx configuration change). The detection/reception of the indication associated with the change of DTx/DRx configuration may be according to one or more examples described herein.

The WTRU may determine an active beam DTx/DRx configuration associated with its detected NTN beam based on one or more of the following: WTRU detected/determined/received DTx/DRx configurations; DTx/DRx being active; DTx/DRx being active; PCI/SSB index/SIB1; beam hopping SIB; tracking area information; RAN notification area information; geographical location on earth; satellite location information; ephemeris data for the satellite; a cell identity; an SSB index; an SSB periodicity; a change in SSB periodicity; a non-cell defining SSB (e.g., beam); a wide NTN beam; a narrow NTN beam; a time interval; the WTRU detecting/receiving an indication associated with a change of DTx/DRx configuration; and/or the WTRU's previously determined active DTx/DRx configuration.

The WTRU may determine an active beam DTx/DRx configuration associated with its detected NTN beam based on the WTRU detection/determination/reception of the DTx/DRx configurations. The WTRU may know, detect, receive, and/or determine a set of DTx/DRx configurations, e.g., according to one or more examples described herein. The DTx/DRx configurations may be associated with different attributes.

The WTRU may determine an active beam DTx/DRx configuration associated with its detected NTN beam based on DTx/DRx being active. For example, the WTRU may determine a beam DTx/DRx configuration if (e.g., only if) the WTRU knows, detects, and/or is indicated by the network that a DTx/DRx configuration is active.

The WTRU may determine an active beam DTx/DRx configuration associated with its detected NTN beam based on PCI/SSB index/SIB1. For example, if the WTRU has one or more DTx/DRx configurations associated with a set of PCI and SSB indices, the WTRU may determine an active configuration based on its detected PCI and SSB index for the NTN beam.

The WTRU may determine an active beam DTx/DRx configuration associated with its detected NTN beam based on beam hopping SIB. The BH-SIB may provide a set of DTx/DRx configurations. The DTx/DRx configurations may be associated with different parameters according to one or more examples described herein. In examples, the BH-SIB may indicate an active DTx/DRx configuration. In examples, the WTRU may read the BH-SIB based on detecting an indication, e.g., system information change or short message. The WTRU may be configured to read the BH-SIB, e.g., after detecting that indication.

The WTRU may determine an active beam DTx/DRx configuration associated with its detected NTN beam based on tracking area information. For example, the tracking area information may be determined by the WTRU and/or based on a change in the tracking area.

The WTRU may determine an active beam DTx/DRx configuration associated with its detected NTN beam based on RAN notification area information. For example, the RAN notification area information may be determined by the WTRU and/or based on a change in the RAN notification area.

The WTRU may determine an active beam DTx/DRx configuration associated with its detected NTN beam based on geographic location on earth. In examples, DTx/DRx configurations may be associated with one or more reference locations. The WTRU may determine a suitable location based on the determined WTRU location and/or reference locations. In examples, the WTRU may determine the DTx/DRx configuration that is associated with the reference location closest to the WTRU location (e.g., the WTRU determined WTRU location, e.g., through GNSS). In examples, the DTx/DRx configurations may be associated with the WTRU location.

The WTRU may determine an active beam DTx/DRx configuration associated with its detected NTN beam based on satellite location information (e.g., based on ephemeris data as broadcast in SIB19).

The WTRU may determine an active beam DTx/DRx configuration associated with its detected NTN beam based on ephemeris data for the satellite (e.g., as broadcast in SIB19).

The WTRU may determine an active beam DTx/DRx configuration associated with its detected NTN beam based on a cell identity.

The WTRU may determine an active beam DTx/DRx configuration associated with its detected NTN beam based on an SSB index.

The WTRU may determine an active beam DTx/DRx configuration associated with its detected NTN beam based on the SSB periodicity. For example, different DTx/DRx configurations may be associated with different SSB periodicities. And the WTRU may determine an active beam DTx/DRx configuration associated with its detected NTN beam based on the SSB periodicity. The WTRU may determine a DTx/DRx configuration based on the detected SSB periodicity.

The WTRU may determine an active beam DTx/DRx configuration associated with its detected NTN beam based on a change in SSB periodicity. In examples, the WTRU may be configured to assume activation and/or deactivation of DTx/DRx configuration based on detecting a change in SSB periodicity. In examples, the change in SSB periodicity may be (e.g., further be) associated with a DTx/DRx configuration. For example, if the SSB periodicity switches from 20 ms to 40 ms, the WTRU may be configured to activate a DTx/DRx configuration that is associated with the SSB periodicity of 40 ms. In examples, the WTRU may have detected an active DTx/DRx configuration for a current periodicity of SSB (e.g., 40 ms). Based on detecting SSB periodicity changing to a second periodicity (e.g., 80 ms), the WTRU may be configured to activate a modified DTx/DRx configuration based on the amount of change detected in the SSB periodicity. In examples, the WTRU may be configured to select a DTx/DRx configuration where the periodicity/cycle of the DTx/DRx configuration is aligned (e.g., the same) as the periodicity of SSB.

The WTRU may determine an active beam DTx/DRx configuration associated with its detected NTN beam based on a non-cell defining SSB (e.g., beam).

The WTRU may determine an active beam DTx/DRx configuration associated with its detected NTN beam based on a wide NTN beam. For example, the WTRU may determine an active beam DTx/DRx configuration if (e.g., when) a satellite is using a wide beam to transmit SSB and (e.g., some) common channels.

The WTRU may determine an active beam DTx/DRx configuration associated with its detected NTN beam based on a narrow NTN beam. For example, the WTRU may determine an active beam DTx/DRx configuration if (e.g., when) a satellite is using a narrow beam to transmit some signals and/or channels, e.g., WTRU-specific signals and/or WTRU-specific channels.

The WTRU may determine an active beam DTx/DRx configuration associated with its detected NTN beam based on time intervals (e.g., time based triggers or service time triggers). For example, the WTRU may determine an active beam DTx/DRx configuration if (e.g., when) certain DTx/DRx configurations get activated and/or deactivated. For example, different DTx/DRx configurations may be associated with different intervals of time. The WTRU may determine the current time, e.g., based on system time, system frame, or epoch time, and may determine a suitable time interval and the associated DTx/DRx configuration to apply.

The WTRU may determine an active beam DTx/DRx configuration associated with its detected NTN beam based on WTRU detection/reception of an indication associated with a change of DTx/DRx configuration according to one or more examples described herein. In examples, the indication may be implicit (e.g., the WTRU detecting a change in one of the DL signal or signal properties). In examples, the indication may be explicit (e.g., short message, paging, paging early indication, system information update, and/or the like). The change indication may provide an indication of active DTx/DRx configuration in absolute terms (e.g., providing an active DTx/DRx configuration) or providing a delta configuration based on the WTRU's previously determined DTx/DRx configuration.

The WTRU may determine an active beam DTx/DRx configuration associated with its detected NTN beam based on WTRU's previously determined active DTx/DRx configuration. This may be an example if (e.g., when) the WTRU has determined an active DTx/DRx configuration and the WTRU detects or receives an indication associated with a change of DTx/DRx configuration according to one or more examples described herein.

In examples, the WTRU may detect a DTx/DRx configuration change. For example, the WTRU may detect an indication associated with a change in DTx/DRx configuration (e.g., an indication to implement a DTx/DRx configuration change). The WTRU may detect an indication associated with a change in active DTx/DRx configuration. The WTRU may detect the indication of the change of DTx/DRx configuration through any one or more of the following: change in SSB periodicity; change in RAN notification area; change in tracking area; a short message, e.g., information embedded directly in the paging PDCCH with or without subsequent data in PDSCH; a paging message; a PEI; WTRU location; a timing indication, e.g., service time indication; satellite ephemeris information, e.g., satellite location; system information update indication, e.g., short message, paging, PEI, and/or the like; value tag update associated with the SIBs, e.g., SIB1, SIB19, BH-SIB, and/or the like; and/or change in the DTx/DRx configuration association attributes, e.g., PCI, SSB index, RAN notification area, tracking area, and/or like.

In examples, the WTRU may be provided timing values and associated DTx/DRx configurations. The WTRU may activate a DTx/DRx configuration based on reaching the associated timing value. The timing value may be provided with respect to epoch time, service time, system time, and/or any other timing reference.

In examples, the WTRU may be provided reference location values and associated DTx/DRx configurations. The WTRU may activate a DTx/DRx configuration based on detecting to be near one of the reference locations. The reference location may be provided as a GNSS based location, a location value and a radius, and/or the like.

Upon detecting a change in DTx/DRx configuration, the WTRU may be configured to determine an active DTx/DRx configuration. The determination of active DTx/DRx configuration may be based on one or more of the examples described herein.

In examples, the WTRU may receive an indication of a change of DTx/DRx configuration. For example, the WTRU may detect or receive an indication from the network. The WTRU may detect or receive an indication from the network. The indication may notify a modification or change to the DTx/DRx configuration, e.g., to the active DTx/DRx configuration.

The WTRU may receive the change indication of the DTx/DRx configuration through the following: the NTN beam through which it received the DTx/DRx configuration and/or another NTN beam (e.g., a second NTN beam) that the WTRU is able to detect/monitor.

The WTRU may receive the update or the modification of the DTx/DRx configuration through the same signaling mechanism through which it received the DTx/DRx configuration or through a different signaling mechanism. In examples, the WTRU may receive the DTx/DRx configuration through SSB or SIB1. The WTRU may receive an update or modification of the DTx/DRx configuration through a SIB (e.g., a special SIB) different from the one providing the first DTx/DRx configuration.

The WTRU may determine the signaling to receive the DTx/DRx change indication based on one or more of the following: frequency band, e.g., the frequency band associated with the NTN beam, where different frequency bands may be associated with different signaling mechanisms; frequency carrier (e.g., ARFCN), e.g., the frequency carrier associated with the NTN beam, where the different carriers may be associated with different signaling mechanisms; SSB periodicity, e.g., based on the WTRU's detection/determination or known SSB periodicity of the NTN beams, where different signaling mechanisms may be associated with different SSB periodicities (e.g., a first signaling type indicating change of DTx/DRx configuration if SSB periodicity is smaller than a threshold and a second signaling type if SSB periodicity is larger than a threshold); change in SSB periodicity (e.g., in examples, a change in SSB periodicity may indicate a change in the active DTx/DRx configuration); NTN beam being detected/known to be a wide/narrow NTN beam, where a signaling type may be associated with a wide beam to receive change of DTx/DRx configuration and another signaling type may be associated with a narrow beam to receive change of DTx/DRx configuration; DTx/DRx Configuration, e.g., in examples, the WTRU may have been provided the signaling through which the network may update the DTx/DRx configuration as part of the DTx/DRx configuration (e.g., if the WTRU receives the (first) DTx/DRx configuration, the configuration may provide the signaling mechanism through which the network may indicate a change/update/modification to the active DTx/DRx configuration); and/or SIB1/SIB19/Beam-Hopping SIB, e.g., in examples, the WTRU may determine the signaling to receive DTx/DRx configuration change indication based on the received system information (e.g., SIB1, SIB19, BH-SIB, and/or the like).

The WTRU may detect or receive the indication of the change of DTx/DRx configuration through one or more of the following: change in SSB periodicity; a short message, e.g., information embedded directly in the paging PDCCH with or without subsequent data in PDSCH; a paging message; a paging early indication; and/or system information.

The WTRU may receive an indication (e.g., a short message, a paging message, a paging early indication message, and/or the like) based on which the WTRU decodes another signal (e.g., a special SIB) to read the update/modification of the DTx/DRx configuration. The special SIB may be the BH-SIB or a different SIB than the one providing the set of DTx/DRx configurations. The WTRU may determine to read the special SIB, e.g., BH-SIB, based on receiving the indication, even if the WTRU may have valid information for that special SIB, e.g., based on the validity timer associated with that special SIB.

In examples, the WTRU may receive an update/modification of the DTx/DRx configuration that does not change some of the parameters for the DTx/DRx configuration (e.g., not changing the cycle or active duration). In examples, the update/modification may change (e.g., completely change) the configuration parameters for DTx/DRx.

In examples, the WTRU may be provided a configuration to request the DTx/DRx configuration (e.g., an UL WUS, a RACH, or SR) that the WTRU may be configured to use after a configured/indicated duration. In examples, the WTRU may be configured to request the DTx/DRx configuration, e.g., after the expiry of a timer. The timer may be provided with the DTx/DRx configuration. In examples, the timer may be based on the last time the WTRU received the DTx/DRx configuration.

In examples, the indication may provide the absolute information of the active configuration. For example, the WTRU may be provided with a set of DTx/DRx configurations. The indication may point to one of the configurations through a suitable mapping. This may be an example if (e.g., when) the WTRU has received a set of DTx/DRx configuration (e.g., received a set of DTx/DRx configuration initially) as part of the system information, e.g., through BH-SIB. In examples, the indication may provide an update and/or modification to a subset of parameters of DTx/DRx configuration, e.g., cycle/periodicity, active duration, and/or the like.

Upon receiving an indication associated with a change in DTx/DRx configuration, the WTRU may be configured to determine an active DTx/DRx configuration. The determination of active DTx/DRx configuration may be based on one or more of examples described herein.

In examples, the WTRU may determine an UL resource based on the DTx/DRx configuration. For example, the WTRU may perform an UL transmission, e.g., a RACH transmission. The WTRU may perform the RACH transmission for an access (e.g., an initial access) or based on detecting an indication from the network, e.g., a short message, paging message, a paging early indication, and/or the like.

The WTRU may determine an UL RACH resource based on any one of the following: SSB/SIB1/SIB19; PCI/SSB index for the WTRU detected/selected beam; and/or the WTRU determined DTx/DRx configuration, e.g., the active DTx/DRx configuration.

In examples, the WTRU may determine a set of RACH resources that is associated with the SSB beams (e.g., SSB indices). The WTRU may select the RACH resources that correspond to its suitable SSB beam. The WTRU may determine the RACH resources (e.g., occasions) based on the DTx/DRx configuration, e.g., the active DTx/DRx configuration. For example, the WTRU may determine (e.g., may only determine) the RACH resources (e.g., occasions) that are in the active duration of the beam DRx configuration to be valid RACH resources and select a suitable resource among its determined valid resources.

The WTRU may transmit RACH over the determined suitable RACH resource.

In examples, the WTRU may not be expected to transmit an UL transmission to an NTN beam/cell in the inactive time as per the WTRU's determined DTx/DRx active configuration associated with the NTN beam/cell.

In examples, the WTRU may determine a DL resource based on the DTx/DRx configuration. For example, the WTRU may receive one or more DL signals and/or channels from the NTN beam. An idle/inactive mode WTRU may monitor the one or more DL signals and/or channels, e.g., to be able to receive paging, perform cell selection/re-selection, neighbor cell monitoring and/or maintaining system information, and/or the like. A connected mode WTRU may be configured with one or more CORESETs to receive subsequent DL or UL scheduling information, may have DL SPS resources, may be configured to receive CSI-RS and perform reporting, HARQ maintenance, and/or the like.

For one or more (e.g., all) semi-statically configured resources (e.g., PDCCH configurations, SPS configurations, CSI-RS configurations, and/or the like), the WTRU may determine to monitor/detect/receive the DL resources based on the following information: SSB; SIB1; resource configuration (e.g., CORESET configuration, SPS configuration, CSI-RS configuration, and/or the like); and/or the WTRU's determined DTx/DRx configuration, e.g., the active DTx/DRx configuration.

In examples, the WTRU may not be expected to monitor/receive one or more (e.g., any) DL transmissions through an NTN beam/cell in the inactive time as per the WTRU's determined DTx/DRx active configuration associated with the NTN beam/cell.

If the WTRU detects a DCI scheduling a DL reception for the WTRU in a time resource that, at least, partially overlaps with the inactive duration according to the WTRU's determined active DTx/DRx configuration, the WTRU may receive the scheduled reception (e.g., the dynamically scheduled reception).

In examples, the WTRU may determine acquiring and/or reacquiring the DTx/DRx configuration. For example, the WTRU may determine to acquire or reacquire the DTx/DRx configuration. The WTRU may determine to acquire or reacquire the set of DTx/DRx configurations. The WTRU may determine to acquire or reacquire DTx/DRx configurations if (e.g., when) the WTRU is configured with DTx/DRx configuration and based on a condition. The condition may be associated with one or more of the following: expiry of system information; and/or system information becoming invalid. In examples, the condition may be associated with the WTRU detecting a change in DTx/DRx configuration, e.g., detecting a change in one of the DTx/DRx configuration association attributes and/or determining that no valid configuration is available associated to updated attributes.

For example, the condition may be associated with the expiry of system information. For example, the system information may be expiring, may have expired, and/or may be about to expire within a configured duration. The WTRU's determination of the expiry of system information may be based on a timer, a time validity, and/or the like. The system information may be the system information related to the DTx/DRx configuration and may be received through SIB1, SIB19, BH-SIB, and/or the like.

The condition may be associated with system information becoming invalid. The system information, e.g., associated with DTx/DRx configuration, may become invalid. This may be an example if (e.g., when) the DTx/DRx configuration is associated with an identity (e.g., a cell identity, tracking area information, RAN notification area information, and/or the like), a geographic location, and/or the like, and based on the WTRU's determination that the relevant identity or relevant geographic location has changed.

Based on the WTRU's determination to acquire DTx/DRx configuration, the WTRU may determine to read system information providing the DTx/DRx configuration. In examples, the WTRU may be configured to perform an UL transmission, e.g., a RACH transmission, to acquire DTx/DRx configuration. The WTRU may be configured to perform an UL transmission, e.g., while the system information associated with DTx/DRx configuration is still valid or within a configured duration after the expiry.

The WTRU may determine an UL RACH resource based on one or more of the following: SSB/SIB1/SIB19; PCI/SSB index for the WTRU detected/selected beam; and/or the WTRU's determined DTx/DRx configuration, e.g., the active DTx/DRx configuration that is expiring, about to expire, or has expired.

In examples, the WTRU may determine a set of RACH resources that is associated with the SSB beams (e.g., SSB indices). The WTRU may select the RACH resources that correspond to its suitable SSB beam. The WTRU may determine the RACH resources (e.g., occasions) based on the DTx/DRx configuration, e.g., the active DTx/DRx configuration. For example, the WTRU may determine (e.g., may only determine) the RACH resources (e.g., occasions) that are in the active duration of the beam DRx configuration to be valid RACH resources and may select a suitable resource among its determined valid resources.

The WTRU may transmit RACH over the determined suitable RACH resource. The WTRU may provide an indication of the system information expiry, e.g., related to the DTx/DRx configuration, as part of its UL transmission.

In examples, the WTRU may provide an indication of detected NTN beam. For example, the WTRU may provide an indication of its detected NTN beams to the network. The WTRU may indicate a detected NTN beam based on one or more of the attributes, e.g., a cell identity, an SSB index, or any other attributes that the WTRU is able to detect for the detected beam. The WTRU may provide an indication of its detected NTN beams to the network based on a condition being fulfilled. The condition may be based on the WTRU's measurement of one of the reference signals received through the NTN beam. In examples, the condition may be based on the RSRP/reference signal received quality (RSRQ) of the NTN beam, e.g., SSB/CSI-RS/RS being better than a configured/known/determined threshold.

The WTRU may provide an indication of the detected beams satisfying the condition to the network. In examples, the WTRU may provide an indication of a fixed number (e.g., only a fixed number) of beams to the network, e.g., only 1, maximum 2 or 3, and/or the like.

The WTRU may provide an indication of the detected NTN beams to the network through a suitable signaling mechanism. In examples, the WTRU may use PHY layer signaling or a higher layer signaling, such as a MAC-control element (CE) or an RRC signaling, e.g., to provide the indication to the network.

In examples, the WTRU may transmit the indication of detected NTN beams to the network as part of the RACH transmission. The RACH transmission may be part of the initial access procedure or triggered by the network, e.g., based on the WTRU detecting a change in system information or DTx/DRx configuration or the WTRU detecting an activation of DTx/DRx configuration, and/or the like. If the WTRU is providing the indication of detected beams to the network as part of RACH transmission, the WTRU may provide the indication as part of Msg-3 of the 4-step RACH procedure or Msg-A of the 2-step RACH procedure.

If the WTRU provides the indication of detected NTN beams to the network, e.g., through RACH transmission, the determination of RACH resource may be based on an active DTx/DRx configuration according to one or more examples described herein. If the WTRU determines the RACH resource based on a first NTN beam, the WTRU may transmit the indication of detected NTN beams using NTN beams other than the first NTN beam to the network.

In examples, the WTRU may receive a configuration of resources over several NTN beams. For examples, the WTRU may receive a configuration of resources over several, e.g., more than one NTN beams. The WTRU may receive a configuration of resources over more than one NTN beams. The NTN beams may be the ones that have been detected and reported by the WTRU to the network according to one or more examples described herein.

In examples, the WTRU may receive a configuration of DL resources for PDCCH monitoring over several NTN beams. The WTRU may receive a configuration from the network where the WTRU is configured to monitor a first PDCCH over the first NTN beam and a second PDCCH over the second NTN beam. The WTRU monitoring for the first PDCCH and the second PDCCH may be configured through one or more of the following: a CORESET and a search space configured for a (e.g., each) of the first/second beam; two search spaces associated with two beams and mapped to a single CORESET; two CORESETs associated with two beams and mapped to a single search space.

The WTRU monitoring of PDCCH over more than one NTN beam may be configured for an idle/inactive mode WTRU, e.g., to monitor paging, and/or the like. The WTRU monitoring of PDCCH over more than one NTN beam may be configured for an RRC connected WTRU over common or WTRU specific search spaces.

In examples, the WTRU may receive a configuration of DL resources for data reception, e.g., semi-persistent scheduling of PDSCH over several NTN beams.

In examples, the WTRU may receive a configuration of UL resources for data transmission, e.g., configured grant PUSCH resources over several NTN beams.

The WTRU may transmit/receive over several NTN beams. For example, the WTRU may monitor the resources for DL reception over several NTN beams. This may be an example if (e.g., when) the WTRU is configured with DL resources for control (e.g., PDCCH) or data (e.g., SPS-PDSCH) over several beams according to one or more examples described herein. To monitor the resources for a (e.g., each) beam, the WTRU may apply the determined active DTx/DRx configuration associated with that beam to monitor (e.g., monitor only) the valid resources in view of the active DTx/DRx configuration.

The WTRU may transmit over UL resources for DL reception over several NTN beams. This may be an example if (e.g., when) the WTRU is configured with DL resources for control (e.g., PDCCH) or data (e.g., SPS-PDSCH) over several beams according to one or more examples described herein. To transmit over the UL resources for a beam, the WTRU may apply the determined active DTx/DRx pattern associated with that beam for resource selection.

In examples, the WTRU may detect/receive an indication of second on duration for DTx/DRx configuration. For example, the WTRU may detect or receive an indication associated with a second on duration of the DTx/DRx configuration. The WTRU may receive the indication for an active DTx/DRx configuration. In examples, the WTRU may receive the indication while in a specific RRC state, e.g., an RRC connected state. In examples, the WTRU may be configured to receive the second on duration DTx/DRx configuration while associated with (e.g., while only associated with/in) an RRC connected state.

The WTRU may receive/detect a second on duration information for beam hopping. The second on duration information may be a configuration for the beam DTx/DRx.

The WTRU may receive the second on duration indication through one or more of the following signaling procedure: system information broadcast (e.g., in a modified legacy SIB or a new SIB); cell level Broadcast signaling; WTRU dedicated RRC configuration; groupcast signaling where the WTRU may be part of the group destined to receive this signaling; dedicated PHY signaling for the WTRU; and/or an implicit detection through reception of broadcast signals (e.g., SSB/SIBs, and/or the like).

In examples, the WTRU may receive a DTx/DRx configuration according to one or more examples described herein. One or more (e.g., only some) of the parameters, e.g., the second on duration and second on duration offset, may be provided in an RRC connected state.

In examples, the WTRU may receive a DTx/DRx configuration, e.g., as a whole, with second on duration, e.g., in a specific RRC state, e.g., an RRC connected state.

In examples, the WTRU may be configured for several active DTx/DRx configurations. For example, the WTRU may be configured with more than one active DTx/DRx configurations. The WTRU may be configured with one or more of the following for active configurations: one active DTx configuration; one active DRx configuration; one active DTx configuration and one active DRx configuration; one active DTx configuration and several active DRx configurations; several active DTx configurations and one active DRx configuration; and/or several active DTx configurations and several active DRx configurations

In examples, the WTRU may be configured with several active DTx and/or DRx configurations if (e.g., when) the DTx/DRx configurations are associated with different signals/channels and/or WTRU RRC state. This may be an example if (e.g., when) one active DTx/DRx configuration is valid for an idle mode operation to receive common channels and/or system information and to be able to perform initial access. A second active DTx/DRx configuration may be provided for a connected mode WTRU operation if (e.g., when) the WTRU has moved to an RRC connected mode.

The second active DTx/DRx configuration associated with a connected mode operation may have the same parameters or different parameters from the first active DTx/DRx configuration. In examples, the WTRU may expect that the periodicity of the second active DTx/DRx configuration is an integer multiple of the first active DTx/DRx configuration and vice versa.

In examples, the WTRU may be configured to apply (e.g., apply only) the second DTx/DRx active configuration. This may for an example attributed to an RRC operation mode of the WTRU. For example, as long as the WTRU operates in an RRC connected mode, the WTRU may be configured to apply (e.g., apply only) the second DTx/DRx active configuration, and if (e.g., when) the WTRU moves to an RRC idle/inactive mode, the WTRU may apply the first DTx/DRx active configuration.

Dynamic SIB based modification to Beam DTx/DRx pattern/configuration may be configured.

A WTRU may receive a set of DTx/DRx configurations. For example, each DTx/DRx configuration from the set of DTx/DRx configuration may be associated with a respective cell identity, a respective beam index, and/or respective geographical area as part of system information, e.g., through a new BH-SIB. The WTRU may determine the NTN DTx/DRx configuration to apply for reception/transmission based on the received configurations, the WTRU location (e.g., determined based on GNSS), and/or received beam identity (e.g., determined from received SSB). The WTRU may determine a different NTN DTx/DRx configuration to apply based on an indication received from the network. The indication may be in the form of a short message, a paging, and/or a paging early indication.

Dynamic SIB based modification to Beam DTx/DRx pattern/configuration may be configured.

A WTRU may camp on an NTN cell and detect an SSB with a given cell ID and SSB index.

Based on the SSB received through the NTN beam, the WTRU may receive and decode SIB1 and SIB19. Based on the information received through SSB/SIB1/SIB19, the WTRU may determine to receive a BH-SIB. BH-SIB may provide a set of DTx/DRx configurations and may indicate the signaling that the network may use to select/update a pattern.

The WTRU may determine a set of DTx/DRx configurations associated with NTN beams based on any one or more of the following: PCI/SSB index/SIB1; BH-SIB; and/or frequency band and/or carrier. The NTN beams may be associated with any combination of PCI and SSB index through configuration.

The WTRU may determine a first active beam DTx and a first active beam DRx configuration associated with the NTN beam based on any one or more of the following: the WTRU determined set of DTx/DRx configurations; PCI/SSB index/SIB1; BH-SIB; tracking area, RAN notification area, and/or WTRU location (e.g., area specific DTx/DRx patterns); timing indication, e.g., service time indication from NTN cell and/or satellite ephemeris information.

The WTRU may detect and/or receive an indication of a change of DTx/DRx configuration from the network. If received from the network, the change indication may be received through any of the (i) short message, (ii) a paging, or (iii) a PEI. The WTRU may determine the signaling procedure (e.g., method) based on the configuration, e.g., as received through the BH-SIB.

The WTRU may determine to read (e.g., and/or decode) the BH-SIB based on the received notification even if the BH-SIB is valid according to the prior received validity timer.

The WTRU may determine a second active beam DTx and a second active beam DRx configuration associated with the NTN beam based on any one or more of the following: the WTRU determined set of DTx/DRx configurations; PCI/SSB index/SIB1; a notification from the network e.g., short message, paging, PEI, and/or the like; BH-SIB (freshly received); tracking area information, RAN notification area information, and/or WTRU location information; a timing indication, e.g., service time indication from an NTN cell; the WTRU determined first active beam DTx and first active beam DRx pattern/configuration; and/or satellite ephemeris information.

The WTRU may monitor the DL signals/channels (e.g., SSBs/SIBs/Paging and/or the like) during (e.g., only during) the active time of the determined second beam DTx pattern/configuration.

The WTRU may transmit RACH requesting to receive BH-SIB based on a condition, e.g., expiry of validity timer associated with the BH-SIB.

The examples described herein may provide flexible control for the satellite operator at the beam level granularity to provide satellite coverage despite the severe HW/RF/power limitations.

The examples described herein may provide WTRU power savings as WTRUs may listen (e.g., may only listen) to SSBs/Paging if (e.g., when) relevant beam is known to be active and may transmit RACH (e.g., may transmit RACH only) on the active ROs.

In examples, the WTRU may be configured with CORESETs/SearchSpaces in two Satellite beams.

For example, the WTRU may be camped over an NTN cell and may detect at least two NTN beams, a first beam and a second beam. The detected NTN beams may be differentiated based on an identity, e.g., PCI, SSB index, and/or the like. The WTRU may determine a beam DTx/DRx pattern/configuration for the detected first and second beams. The WTRU may transmit an indication to the network for the second NTN beam based on a condition being fulfilled (e.g., the second beam RSRP is better than a threshold). The indication may be transmitted on a resource derived/determined based on the first NTN beam. The WTRU may receive a configuration from the network. The WTRU may be configured to monitor a first PDCCH over the first NTN beam and a second PDCCH over the second NTN beam.

In examples, as described herein, the WTRU may be configured with CORESETs/SearchSpaces in two Satellite beams.

In examples, the WTRU may be camped on an NTN cell and may detect a first NTN beam, e.g., with a given cell ID and SSB index.

Based on the detected first NTN beam, the WTRU may receive and/or decode SIB1, SIB19, BH-SIB, and/or the like.

The WTRU may determine a first beam DTx/DRx pattern/configuration associated with its detected NTN beam based on one or more of the following: PCI, SSB index, SIB1, and/or BH-SIB.

The WTRU may transmit RACH to the network, e.g., according to the RACH resource (e.g., RO and preamble, and/or the like) determined based on the information received from the first NTN beam.

The WTRU may provide an indication to the network for a second NTN beam (e.g., a cell ID and SSB index for the second NTN beam) based on a condition being fulfilled (e.g., the RSRP of the second beam SSB being better than a threshold). The WTRU may transmit the indication as part of the Msg-3 (e.g., Msg-A) RACH.

The WTRU may receive a configuration from the network. The WTRU may be configured to monitor a first PDCCH over the first NTN beam and a second PDCCH over the second NTN beam. The WTRU monitoring for the first PDCCH and the second PDCCH may be configured through one or more of the following: a CORESET and a search space configured for each of the first/second beam; two search spaces associated with two beams and mapped to a single CORESET; and/or two CORESETs associated with two beams and mapped to a single search space.

The WTRU may monitor the PDCCH for the first beam according to the DTx/DRx pattern determined for the first beam and may monitor the PDCCH for the second beam according to the DTx/DRx pattern determined for the second beam.

Additional service time (e.g., for DL and/or UL) for the WTRUs may be configured and may be able to receive more than one beam, e.g., by configuring PDCCH monitoring in multiple satellite beams.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU) comprising:
a processor configured to:
receive a synchronization signal block (SSB) using a non-terrestrial network (NTN) beam;
receive at least one of system information block (SIB) or a beam hopping SIB (BH-SIB), wherein the SIB comprises information associated with a set of discontinuous transmission (DTx)/discontinuous reception (DRx) configurations, and wherein the BH-SIB indicates the set of DTx/DRx configurations, wherein the set of DTx/DRx configurations is associated with the NTN beam;
determine the set of DTx/DRx configurations based on at least one of the SIB or the BH-SIB;
determine an active beam DTx/DRx configuration from the set of DTx/DRx configurations; and
monitor for a downlink signal during an active time associated with the active beam DTx/DRx configuration.

2. The WTRU of claim 1, wherein the active beam DTx/DRx configuration is determined from the set of DTx/DRx configurations based on at least one of the set of DTx/DRx configurations, a physical cell identity (PCI), an SSB index, an SIB1, the BH-SIB, tracking area information, radio access network (RAN) notification area information, WTRU location information, a timing indication, or satellite ephemeris information.

3. The WTRU of claim 1, wherein the BH-SIB is a first BH-SIB, and wherein the processor is configured to:
determine a validity timer associated with the first BH-SIB;
determine that the validity timer has expired; and
based on the determination that the validity timer has expired, transmit an uplink (UL) transmission that indicates a request for a second BH-SIB, wherein the UL transmission comprises a random access channel (RACH) message.

4. The WTRU of claim 1, wherein the SIB comprises at least one of SIB1 or SIB19.

5. The WTRU of claim 1, wherein the active beam DTx/DRx configuration is a first active beam DTx/DRx configuration, wherein the downlink signal is a first downlink signal, wherein the active time is a first active time, and wherein the processor is configured to:
receive an indication to implement a DTx/DRx configuration change, wherein the indication is received using at least one of a short message, a paging, or a paging early indication (PEI);
based on the indication, determine a second active beam DTx/DRx configuration from the set of DTx/DRx configurations; and
monitor for a second downlink signal during a second active time associated with the second active beam DTx/DRx configuration.

6. The WTRU of claim 5, wherein the BH-SIB is a first BH-SIB, and wherein the second active beam DTx/DRx configuration is determined from the set of DTx/DRx configurations based on at least one of: the set of DTx/DRx configurations, a PCI, an SSB index, an SIB1, the indication to implement the DTx/DRx configuration change, a second BH-SIB, tracking area information, RAN notification area information, WTRU location information, a timing indication, the first active beam DTx/DRx configuration, or satellite ephemeris information.

7. The WTRU of claim 1, wherein the set of DTx/DRx configurations is determined based on at least one of a PCI, an SSB index, an SIB1, the BH-SIB, a frequency band information, or carrier information.

8. The WTRU of claim 1, wherein each DTx/DRx configuration from the set of DTx/DRx configurations is associated with at least one of a respective cell identity, a respective SSB index, a respective beam index, or a respective geographical area information.

9. A method comprising:
receiving a synchronization signal block (SSB) using a non-terrestrial network (NTN) beam;
receiving at least one of system information block (SIB) or a beam hopping SIB (BH-SIB), wherein the SIB comprises information associated with a set of discontinuous transmission (DTx)/discontinuous reception (DRx) configurations, and wherein the BH-SIB indicates the set of DTx/DRx configurations, wherein the set of DTx/DRx configurations is associated with the NTN beam;
determining the set of DTx/DRx configurations based on at least one of the SIB or the BH-SIB;
determining an active beam DTx/DRx configuration from the set of DTx/DRx configurations; and
monitoring for a downlink signal during an active time associated with the active beam DTx/DRx configuration.

10. The method of claim 9, wherein the active beam DTx/DRx configuration is determined from the set of DTx/DRx configurations based on at least one of the set of DTx/DRx configurations, a physical cell identity (PCI), an SSB index, an SIB1, the BH-SIB, tracking area information, radio access network (RAN) notification area information, WTRU location information, a timing indication, or satellite ephemeris information.

11. The method of claim 9, wherein the BH-SIB is a first BH-SIB, and wherein the method comprises:
determining a validity timer associated with the first BH-SIB;
determining that the validity timer has expired; and
based on the determination that the validity timer has expired, transmitting an uplink (UL) transmission that indicates a request for a second BH-SIB, wherein the UL transmission comprises a random access channel (RACH) message.

12. The method of claim 9, wherein the SIB comprises at least one of SIB1 or SIB19.

13. The method of claim 9, wherein the active beam DTx/DRx configuration is a first active beam DTx/DRx configuration, wherein the downlink signal is a first downlink signal, wherein the active time is a first active time, and wherein the method comprises:
receiving an indication to implement a DTx/DRx configuration change, wherein the indication is received using at least one of a short message, a paging, or a paging early indication (PEI);
based on the indication, determining a second active beam DTx/DRx configuration from the set of DTx/DRx configurations; and
monitoring for a second downlink signal during a second active time associated with the second active beam DTx/DRx configuration.

14. The method of claim 13, wherein the BH-SIB is a first BH-SIB, and wherein the second active beam DTx/DRx configuration is determined from the set of DTx/DRx configurations based on at least one of: the set of DTx/DRx configurations, a PCI, an SSB index, an SIB1, the indication to implement the DTx/DRx configuration change, a second BH-SIB, tracking area information, RAN notification area information, WTRU location information, a timing indication, the first active beam DTx/DRx configuration, or satellite ephemeris information.

15. The method of claim 9, wherein the set of DTx/DRx configurations is determined based on at least one of a PCI, an SSB index, an SIB1, the BH-SIB, a frequency band information, or carrier information.

16. The method of claim 9, wherein each DTx/DRx configuration from the set of DTx/DRx configurations is associated with at least one of a respective cell identity, a respective SSB index, a respective beam index, or a respective geographical area information.
